(19) United States
(12) Patent Application Publication
(10) Pub. No.: US 2019/0057017 A1
(43) Pub. Date: Feb. 21, 2019

(54) Correlation Of Function Calls To Functions In Asynchronously Executed Threads

(71) Applicant: Microsoft Technology Licensing, LLC, Redmond, WA (US)

(72) Inventor: Jordi MOLA, Bellevue, WA (US)

(73) Assignee: Microsoft Technology Licensing, LLC, Redmond, WA (US)

(21) Appl. No.: 15/678,819

(22) Filed: Aug. 16, 2017

(51) Int. Cl. G06F 11/36; G06F 11/34; G06F 11/30

(52) U.S. Cl. CPC G06F 11/3636; G06F 11/302; G06F 11/3471

(57) ABSTRACT

A trace of the execution of a program is recorded. This program trace includes various information regarding each instruction of the program that is executed, such as the values or locations of any inputs to the instruction, the values or locations of any outputs by the instruction, and so forth. After execution of the program completes, an execution analysis system analyzes the program trace and can perform various different tasks. One such task that the execution analysis system can perform is automatically identifying potential concurrency problems with the program resulting from asynchronous execution of threads of the program. Another such task that the execution analysis system can perform is reordering the information in the program trace so that a linear view of the information can be displayed in accordance with the order of the code in the program rather than the order in which the asynchronous threads were executed.

### BACKGROUND

As computer technology has advanced, computers and computer programs have become increasingly complex. While this complexity has many advantages, such as improved performance and capabilities, it is not without its problems. One such problem is that it can be difficult for program developers to find potential bugs or issues with their computer programs. This can lead to frustrating and time-intensive debugging sessions for the developer, and can also result in computer programs being released with bugs or other issues.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, a program trace that is a recording of execution of multiple threads of a program on a computing device is obtained. The multiple threads include multiple asynchronous threads, and the program trace includes information regarding instructions of the program that is executed on the computing device. Function calls in a first of the multiple threads are correlated with functions executed in the multiple asynchronous threads. The correlated function calls and functions are used to reorder the trace information for one or more of the asynchronous threads in accordance with the order of code in the program rather than the order in which the asynchronous threads were executed. The reordered trace information is exposed. The exposed reordered trace information can be displayed so that a linear view of the trace information is displayed in accordance with the order of the code in the program rather than the order in which the multiple asynchronous threads were executed.

In accordance with one or more aspects, a program trace that is a recording of execution of multiple threads of a program on a computing device is obtained. The multiple threads include multiple asynchronous threads, and the program trace includes information regarding instructions of the program that is executed on the computing device. Function calls in a first of the multiple threads are correlated with functions executed in the multiple asynchronous threads. A determination is made, from the program trace, whether a pair of the multiple asynchronous threads accessed a same memory address. In response to determining that the pair of asynchronous threads accessed the same memory address, a determination is made, based at least in part on the types of accesses the pair of asynchronous threads made to the same memory address, whether there is a potential concurrency problem with the pair of asynchronous threads. These types of accesses can include read accesses or write accesses. Additionally, in response to determining that there is a potential concurrency problem with the pair of asynchronous threads, a warning notification that there is a potential concurrency problem with the pair of asynchronous threads is generated, the warning including an indication of the memory address.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 illustrates an example system implementing the correlation of function calls to functions in asynchronously executed threads in accordance with one or more embodiments.

FIG. 2 illustrates an example portion of a program in accordance with one or more embodiments.

FIG. 3 illustrates an example execution sequence of instructions of a program in accordance with one or more embodiments.

FIG. 4 illustrates an example of using events to correlate function in one thread with function in each of one or more additional authentication system threads.

FIG. 5 illustrates an example of using characteristics of a function executed in a thread to correlate the function being called from one thread and executed in another asynchronous thread.

FIG. 6 shows an example of displaying the trace information in a linear view in accordance with one or more embodiments.

FIG. 7 is a flowchart illustrating an example process for a device implementing the correlation of function calls to functions in asynchronously executed threads in accordance with one or more embodiments.

FIG. 8 is a flowchart illustrating another example process for a device implementing the correlation of function calls to functions in asynchronously executed threads in accordance with one or more embodiments.

FIG. 9 illustrates an example system that includes an example computing device that is representative of one or more systems and/or devices that may implement the various techniques described herein.

### DETAILED DESCRIPTION

Correlation of function calls to functions in asynchronously executed threads is discussed herein. A trace of the execution of a program is recorded. This trace, also referred to as a program trace, includes various information regarding each instruction of the program that is executed, such as the values or locations of any inputs to the instruction, the values or locations of any outputs by the instruction, and so forth. The program is executed and different parts of the program can be executed asynchronously. For example, when a function call is made, a new thread can be created and the function that is called can be executed in this newly created thread.

After execution of the program completes, an execution analysis system analyzes the program trace and can perform various different tasks. One such task that the execution analysis system can perform is automatically identifying potential concurrency problems with the program resulting from asynchronous thread execution. Another such task that the execution analysis system can perform is reordering the information in the program trace so that a linear view of the information in accordance with the order of the code in the program rather than the order in which the asynchronous threads were executed is available and can be, for example, displayed.

The techniques discussed herein allow the execution of asynchronous threads to be analyzed, determining when the execution of such threads can lead to bugs or performance issues for the computer program as well as the computing device running the program. Potential concurrency problems can be identified, allowing the program to be corrected and operation of the program and computing device improved. Furthermore, the techniques discussed herein allow execution of asynchronous threads to be analyzed and information regarding the execution of the program displayed to program developers so that potential bugs or problems with the programs can be more easily identified. This display of information regarding the execution of the program is linearized so that a linear view of the information is displayed in accordance with the order of the code in the program rather than the order in which the asynchronous threads were executed.

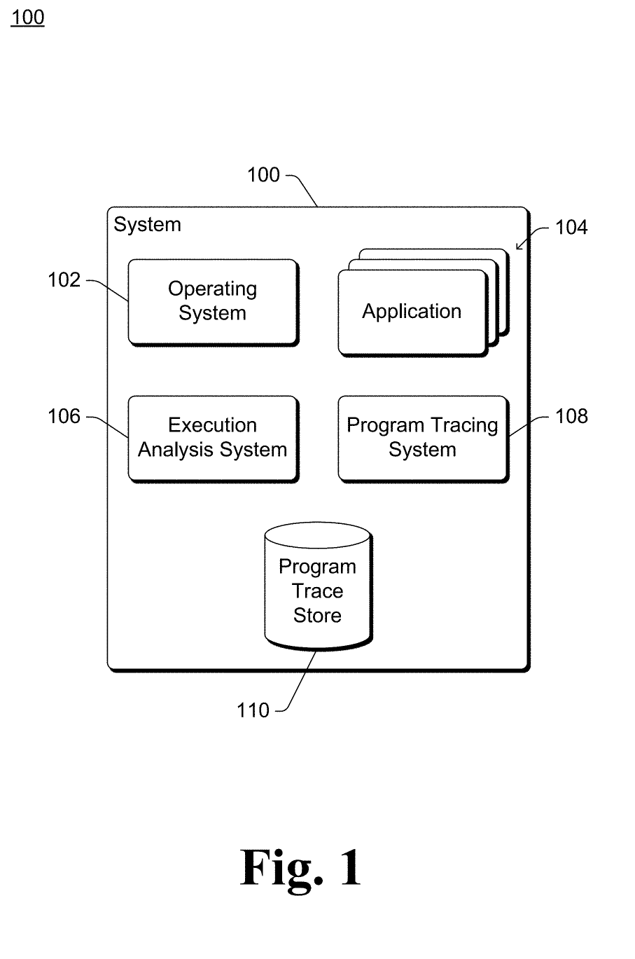

FIG. 1 illustrates an example system 100 implementing the correlation of function calls to functions in asynchronously executed threads in accordance with one or more embodiments. The system 100 is implemented by one or more computing devices. Each computing device that implements at least part of the system 100 can be any of a variety of different types of devices, such as a desktop computer, a server computer, a laptop or netbook computer, a mobile device (e.g., a tablet or phablet device, a cellular or other wireless phone (e.g., a smartphone), a notepad computer, a mobile station), a wearable device (e.g., eyeglasses, head-mounted display, watch, bracelet, augmented reality (AR) devices, virtual reality (VR) devices), an entertainment device (e.g., an entertainment appliance, a set-top box communicatively coupled to a display device, a game console), Internet of Things (IoT) devices (e.g., objects or things with software, firmware, and/or hardware to allow communication with other devices), a television or other display device, an automotive computer, and so forth. Thus, a computing device implementing at least part of the system 100 may range from a full resource device with substantial memory and processor resources (e.g., personal computers, game consoles) to a low-resource device with limited memory and/or processing resources (e.g., traditional set-top boxes, hand-held game consoles).

The system 100 includes an operating system 102, one or more applications 104, an execution analysis system 106, a program tracing system 108, and a program trace store 110. In one or more embodiments, each of the operating system 102, the one or more applications 104, the execution analysis system 106, the program tracing system 108, and the program trace store 110 are implemented on a single computing device. Additionally or alternatively, different parts of the system 100 can be implemented on different computing devices. For example, the program tracing system 108 can be implemented on one computing device along with the one or more applications 104 and the operating system 102, and the execution analysis system 106 can be implemented on a different computing device. Continuing with this example, the program trace store 110 can be implemented on the same computing device as the program tracing system 108, on the same computing device as the execution analysis system 106, and/or on a different computing device (e.g., accessed via a data network such as a local area network and/or the Internet).

The operating system 102 manages the running of applications 104 on a computing device of the system 100. The operating system 102 provides an interface for application 104 to access various functionality and hardware components of the computing device. Each application 104 can be any of a variety of different types of applications, such as a productivity application, an entertainment application, a Web application, and so forth. Any number of applications 104 can be included in the system 100.

The program tracing system 108 generates a program trace for a program running on a computing device of the system 100, and stores the program trace in the program trace store 110. In one or more embodiments, the program for which a program trace is generated is an application 104. Additionally or alternatively, the program for which a program trace is generated can be other programs, such as a program of the operating system 102. The program tracing store 110 can be any of a variety of different storage devices, such as random access memory (RAM), solid state memory (e.g., Flash memory), a magnetic disk, and so forth.

The program tracing system 108 generates a program trace for a program being executed on a computing device. The program trace includes various information (also referred to as program trace information) regarding each instruction of the program that is executed, such as the values or locations of any inputs to the instruction, the values or locations of any outputs by the instruction, and so forth. Various additional information regarding the state or settings of the computing device can also be included in the program trace. For example, particular register settings before and/or after execution of the instruction can be included in the program trace, values on an operating system stack before and/or after execution of the instruction can be included in the program trace, a timestamp of when the instruction was executed can be included in the program trace, and so forth. This program trace information for an instruction, as well as any additional information regarding the state or settings of the computing device before and/or after executing the instruction, is also referred to as a trace unit.

The program tracing system 108 can be implemented in a variety of different manners. For example, the program tracing system 108 can be or include the Event Tracing for Windows (ETW) service or an analogous service. By way of another example, the program tracing system 108 can be or include a module or system that provides performance counters' values, telemetry data, and so forth. Although illustrated as separate from the operating system 102, the program tracing system 108 can additionally or alternatively be included as part of the operating system 102.

A program is typically written as a sequence of instructions, also referred to as the program code or simply code. Although these instructions are written in a particular sequence, they are not always executed in that particular sequence. In one or more embodiments, the developer of the program identifies instructions that can be executed in a different sequence (e.g., by using particular instructions, parameters, tags, etc.). Additionally or alternatively, the operating system 102 can apply any of a variety of different public and/or proprietary techniques to determine which instructions can be executed in a different sequence.

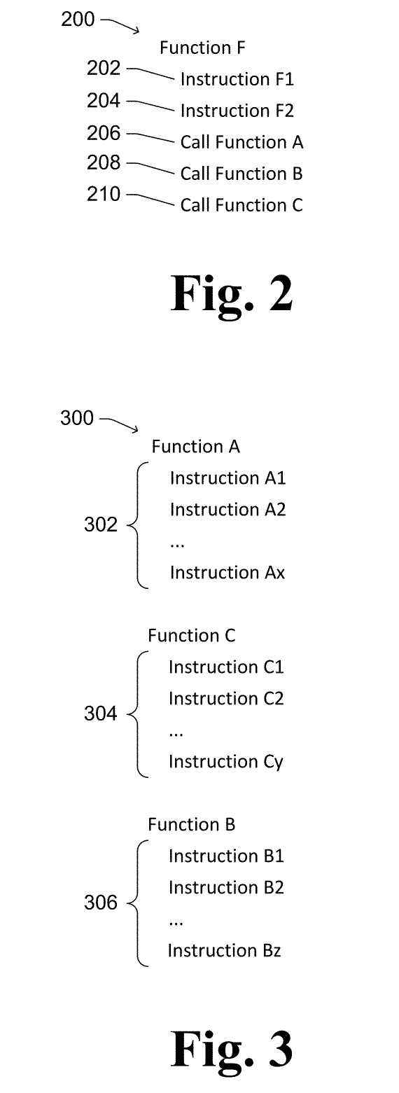

FIG. 2 illustrates an example portion 200 of a program in accordance with one or more embodiments. The portion 200 includes a sequence of instructions in the following order: instruction 202 (Instruction F1), instruction 204 (Instruction F2), instruction 206 (a call to invoke Function A), instruction 208 (a call to invoke Function B), and instruction 208 (a call to invoke Function C).

FIG. 3 illustrates an example execution sequence 300 of some of the instructions in the portion 200 of the program in accordance with one or more embodiments. As discussed above, the instructions 202-210 may not be executed in the order in which they are shown in FIG. 2. For example, the execution sequence 300 shows a sequence of multiple (x) instructions 302 of Function A executing (resulting from Function A being invoked by instruction 206), followed by multiple (y) instructions 304 of Function C executing (resulting from Function C being invoked by instruction 210), followed by multiple (z) instructions 306 of Function B executing (resulting from Function B being invoked by instruction 208).

Returning to FIG. 1, execution of the calls to invoke (begin execution of) Function A, Function B, and Function C of FIG. 2 result in the operating system 102 assigning a thread in which the invoked function is executed. A thread can be assigned in a variety of different manners, such as creating a new thread, using an existing thread that is currently in a non-executing state, interrupting a thread that is currently executing, obtaining a thread from a cached pool of threads, and so forth. Thus, each of Function A, Function B, and Function C is executed in a different thread. The operating system 102 executes these different threads asynchronously, so the operating system 102 can schedule these threads for execution at different times, resulting in no guarantee as to what order the Functions A, B, and C will execute.

Which functions of the program can be executed asynchronously can be determined in a variety of different manners. In one or more embodiments, the program developer specifies which functions can be executed asynchronously when writing the program. A specific keyword or parameter can be used in the functions or function names to specify that they can be executed asynchronously with other functions, such as inclusion of the keyword “ASYNC”. Additionally or alternatively, absence of a particular keyword or parameter can be used to specify that a function can be executed asynchronously with other functions.

The program developer can also specify which functions are to wait for the results of which other functions. A function that is to wait for the result of another particular one or more functions cannot be executed asynchronously with those particular one or more functions. A specific keyword or parameter can be used in the functions or function names to specify that they need to wait for a previous function to complete execution (e.g., because the function relies on the output of a previous function). The specific keyword can be, for example, the keyword “WAIT” followed by the name or other identifier of the function completion of which is to be waited for.

It should be noted that a function can execute asynchronously with some functions but not with other functions. For example, assume that a program calls four functions: Function 1, Function 2, Function 3, and Function 4. Further assume that the program developer has indicated that Function 1, Function 2, Function 3, and Function 4 can be executed asynchronously, and that Function 4 is to wait for the results of Function 2 before being executed. In this example, Function 1 can be executed asynchronously with any one or more of Function 2, Function 3, and Function 4. Similarly, Function 3 can be executed asynchronously with any one or more of Function 1, Function 2 and Function 4. However, Function 2 can be executed asynchronously with one or more of Function 1 and Function 3, but cannot be executed asynchronously with Function 4 because Function 4 is to wait for the results of Function 2 before being executed. Furthermore, Function 4 can be executed asynchronously with one or more of Function 1 and Function 3, but cannot be executed asynchronously with Function 2 because Function 4 is to wait for the results of Function 2 before being executed.

If two threads execute asynchronously, the first thread can begin and complete execution prior to the second thread beginning execution, the second thread can begin and complete execution prior to the first thread beginning execution, or the first and second threads can execute concurrently with the operating system switching which thread is executing at any particular time.

The program tracing system 108 records program trace information during execution of the instructions in the program. Thus, referring to FIG. 3, the program tracing system 108 records program trace information when executing instructions 302 of Function A, instructions 304 of Function C, and instructions 306 of Function B.

The execution analysis system 106 obtains the program trace stored in the program trace store 110 and analyzes the program trace. This analysis can be used for various different purposes, such as to re-order information in a display of the program trace so that the program trace information is displayed in the order in which the code is written rather than the order in which the instructions are executed, to identify potential concurrency issues that may arise from the asynchronous execution of threads (e.g., the execution of Functions A, B, and C), and so forth.

The execution analysis system 106 correlates functions in one thread with functions in each of one or more additional asynchronous threads. This correlation refers to identifying which threads are executing which functions in a program. For example, referring to FIGS. 2 and 3, Function F is executed in one thread, Function A is executed in another thread, Function B is executed in another thread, and function C is executed in yet another thread. By knowing which thread a function is executing in, the execution analysis system 106 can perform various analysis functions, such as re-ordering information in a display of the program trace, identifying potential concurrency issues, and so forth as discussed in more detail below.

The execution analysis system 106 can correlate functions in one thread with functions in each of one or more additional asynchronous threads in a variety of different manners. In one or more embodiments, the execution analysis system 106 makes uses of events to correlate functions in one thread with functions in each of one or more additional asynchronous threads. Events refer to data that is added to the program trace that identify a particular action, one of which is calling or invoking a function.

When an asynchronous function is called, the program tracing system 108 adds a tag (meta data) to the program trace information. The tag is added to the program trace information for the instruction that called the asynchronous function (e.g., instruction 206). The tag is a value that allows the instruction that calls an asynchronous function to be distinguished from other instructions that call asynchronous functions. In one or more embodiments, the tag value is a globally unique identifier (GUID). The tag value can be obtained in any of a variety of different manners, such as by generating a random or pseudo random number, by selecting the next value in a sequence of previously generated values (e.g., previously generated and stored by the program tracing system 108), and so forth.

The operating system 102 executes the asynchronous function in a new thread. Additionally, the program tracing system 108 also adds the same tag to the program trace information for each (or at least one) instruction that is executed in that new thread.

The execution analysis system 106 uses these tags to correlate the function being called from one thread and executed in another asynchronous thread. The same tag value is added to both caller and called instructions, so they can be readily matched up by the execution analysis system 106.

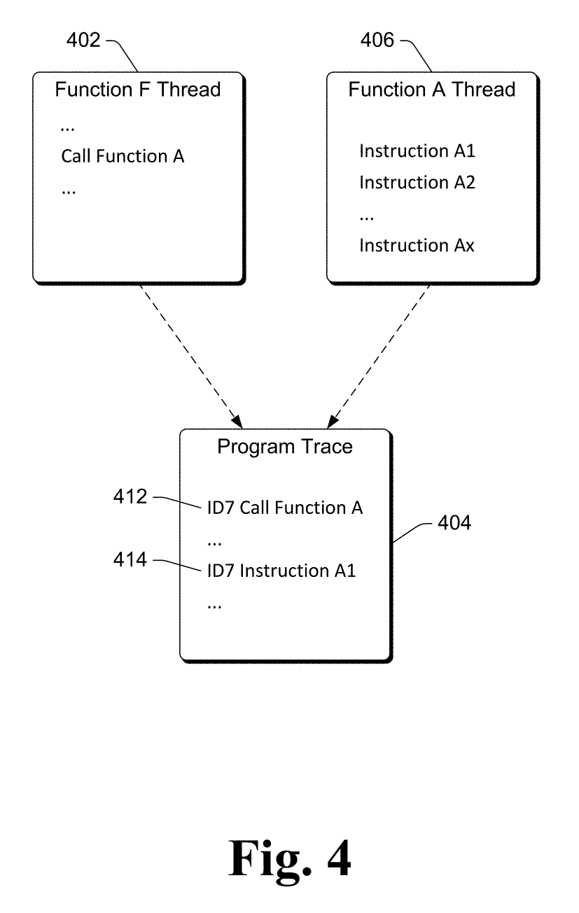

FIG. 4 illustrates an example of using events to correlate function in one thread with function in each of one or more additional authentication system threads. Referring also to FIGS. 2 and 3, the Function F is executed in a thread 402. When the Call Function A instruction 206 is executed the program tracing system 108 obtains a tag value (which is “ID7” in the example of FIG. 4) and records program trace information 412 in the program trace 404 that indicates Function A was called by Function F and has associated meta data that is the obtained tag value ID7. The operating system runs Function A in a new thread 406, and the program tracing system 108 also adds the obtained tag value ID7 to the program trace information 414 for at least one of the instructions 302.

Returning to FIG. 1, it should be noted that a function can be called multiple times. Each time a function is called the called function may be executed in a different thread. A different tag value is obtained for each time a function is called, even if the function happens to be called using a thread that was previously used to call the function, allowing the different callings of the function to be correlated.

Additionally or alternatively, the execution analysis system 106 can use other techniques to correlate functions in one thread with functions in each of one or more additional asynchronous threads. For example, situations can arise in which tag values are not added to the program trace information. These situations can arise for various reasons, such as the storing of tag values being a configurable operation that is currently deactivated by the program tracing system 108.

In such situations, various different characteristics of an asynchronous function that is called can be compared to characteristics of a function executed in a thread to correlate the function being called from one thread and executed in another asynchronous thread. These characteristics can include, for example, function parameter values, function return values, values of memory locations accessed by the function call, any information regarding ordering (e.g., any information that may imply an ordering of one function before another), combinations thereof, and so forth. Information ordering can include, for example, causality (e.g., if function Y is only called by function X, Y(1) is a particular invocation of function Y, and X(1) is a particular invocation of function X, then it is not possible for X(1) to be the caller of Y(1) if Y(1) was executed prior to X(1)).

The execution analysis system 106 can analyze the program trace information and correlate functions in one thread with functions in each of one or more additional asynchronous threads. The execution analysis system 106 can compare characteristics of functions in the different threads and determine which functions correlate to one another. If the characteristics of a function in one thread match (e.g., are the same as) the characteristics of a function in another thread, then those functions are correlated. An additional rule can optionally be imposed that if the characteristics of a function in one thread match (e.g., are the same as) the characteristics of one and only one other function in another thread, then those functions are correlated.

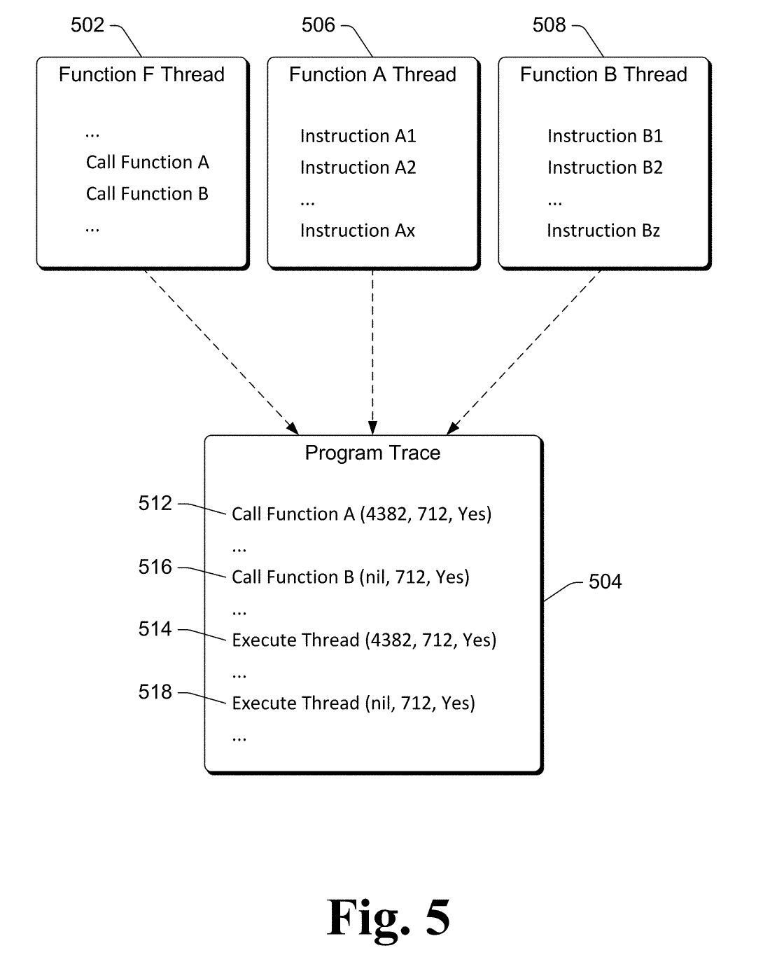

FIG. 5 illustrates an example of using characteristics of a function executed in a thread to correlate the function being called from one thread and executed in another asynchronous thread. Referring also to FIGS. 2 and 3, the Function F is executed in a thread 502. Assume that Call Function A instruction 206 has parameter values of 4382, 712, and Yes. When the Call Function A instruction 206 is executed the program tracing system 108 records program trace information 512 in the program trace 504 that indicates Function A was called by Function F with parameter values of 4382, 712, and Yes. The operating system runs Function A in a new thread 506, and the program tracing system 108 also records program trace information 514 in the program trace 504 that indicates the function running in the thread 506 was executed with parameter values of 4382, 712, and Yes. Further assume that Call Function B instruction 208 has parameter values of nil, 712, and Yes. When the Call Function B instruction 208 is executed the program tracing system 108 records program trace information 516 in the program trace 504 that indicates Function B was called by Function F with parameter values of nil, 712, and Yes. The operating system runs Function B in a new thread 508, and the program tracing system 108 also records program trace information 518 in the program trace 504 that indicates the function running in the thread 508 was executed with parameter values of nil, 712, and Yes.

The execution analysis system 106 correlates the Function A from Function F with the function executing in thread 506 based on the program trace 504. The execution analysis system 106 identifies, based on trace information 512 and trace information 514, that the Function A from Function F has the same parameter values as the function executing in thread 506. Based on this identification, the execution analysis system 106 correlates the Function A from Function F with the function executing in thread 506.

Continuing with this example, if multiple functions in other threads received parameter values 4382, 712, and Yes, then the execution analysis system 106 can use additional characteristics to correlate the functions. For example, the execution analysis system 106 can analyze the program trace information and identify the return values of the functions in the threads. If the function in one thread returned a value of True and the function in another thread returned a value of False, and from the program trace information the execution analysis system 106 knows that in response to the Call Function A instruction 206 the Function F received a return value of False, then the execution analysis system 106 knows that the other thread executing a function that received parameter values 4382, 712, and Yes, and returned a value of False, is the thread that includes the function that executed Function A in response to the instruction 206.

Returning to FIG. 2, once the function executed in a thread is correlated to a call to that function from function F, all instructions executed in that thread are also associated with the call to that function from function F. This correlation of additional instructions can be made, for example, by including in the program trace information an indication of (e.g., an identifier assigned to) the thread in which the function executes.

Returning to FIG. 1, the execution analysis system 106 can leverage the program trace for a program to facilitate debugging and analysis of the program. By correlating functions in a thread with functions in each of one or more additional asynchronous threads, the execution analysis system 106 can readily determine from the program trace which executed instructions correspond to which functions. This allows the execution analysis system 106 to reorder the trace information for the asynchronous threads in accordance with the order of code in the program rather than the order in which the asynchronous threads were executed and expose the reordered trace information. The reordered trace information refers to the trace information being ordered substantially in accordance with the order of the code in the program rather than the order in which the multiple asynchronous threads were executed. The reordered trace information can be exposed in various manners, such as storing the reordered trace information in a file or buffer as discussed in more detail below.

Displaying the reordered trace information provides the user with a linear view of the trace information that is displayed in accordance with the order of the code in the program rather than the order in which the asynchronous threads were executed.

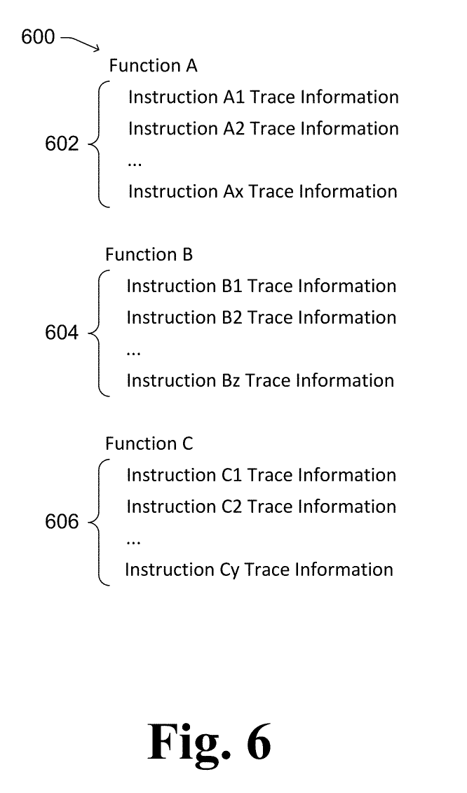

FIG. 6 shows an example of displaying the trace information in a linear view in accordance with one or more embodiments. In the example of FIG. 6, it is assumed that the Function F as shown in FIG. 2 is executed with Function A, Function B, and Function C being executed asynchronously as shown in FIG. 3. A linear view 600 of the instructions is shown, so that the sequence of trace information 602 resulting from Function A executing is displayed, followed by the sequence of trace information 604 resulting from Function B executing, followed by the sequence of trace information 604 resulting from Function C executing.

As can be seen in FIG. 6, the trace information for Function A, Function B, and Function C is displayed in the same order as Function A, Function B, and Function C are written in the program (as shown in FIG. 2) rather than the order in which Function A, Function B, and Function C were executed (as shown in FIG. 3).

Although trace information for particular instructions is illustrated in FIG. 6, it should be noted that various additional information can be displayed in a linearized manner. This additional information can include any information that may be displayed in a typical debugger, such as the stack representation, register values, and so forth.

Additionally or alternatively, various different automated program analysis tools can be used to analyze the program and attempt to identify potential bugs or problems in programs. The reordered trace information can be exposed to and used by such analysis tools so that the analysis tools operate on the trace information in accordance with the order of the code in the program rather than the order in which the asynchronous threads were executed. Various different public and/or proprietary automated program analysis tools can be used, such as tools to check whether a handle was used before the handle was obtained, tools to check whether a handle was used after the handle was released, and so forth. Such analysis tools can be separate from, or alternatively included as part of, the execution analysis system 106. These automated program analysis tools can operate based on the linearized trace information, which can simplify their operation and increase their ability to detect potential bus or problems.

Returning to FIG. 1, in one or more embodiments the execution analysis system 106 also uses the program trace to detect potential concurrency problems and notify a user of the system 100 of these potential concurrency problems. A potential concurrency problem refers to a potential problem or issue that may arise in executing the program due to different functions of the program being executed asynchronously in different threads. For example, if two functions in two asynchronous threads write to the same memory address, then the behavior of the program can vary based on the order in which the two asynchronous threads are executed.

Which functions of a program can be executed asynchronously can be determined in various different manners as discussed above. The execution analysis system 106 can analyze the program or receive information from the operating system 102 to obtain this information and thus know which functions of the program can be executed asynchronously. The execution analysis system 106 can also correlate these functions with program trace information from different threads in various different manners as discussed above.

The execution analysis system 106 thus has knowledge of which program trace information is program trace information for threads that executed functions that can function concurrently. The execution analysis system 106 leverages this knowledge to identify potential concurrency problems in the threads that are executed asynchronously. The execution analysis system 106 analyzes the program trace information for threads that can be executed asynchronously to identify common (the same) memory addresses accessed by the asynchronous threads.

In one or more embodiments, the execution analysis system 106 analyzes the program trace information for pairs of threads that include functions that can be executed asynchronously with one another, and determines each pair of asynchronous threads that access a same memory address. The memory addresses accessed by a function executed in a thread are included in the program trace information for that thread, and thus can be readily accessed and analyzed by the execution analysis system 106.

The execution analysis system 106 determines whether there is a potential concurrency problem in a pair of threads based on the types of accesses to the memory address performed in the pair of threads. If two threads do not access the same memory address, then there is no potential concurrency problem for the two threads. However, if two threads do access the same memory address, then whether there is a potential concurrency problem depends on whether the accesses to the memory address are read accesses or write accesses.

If two threads both access the same memory address with only read accesses, then the execution analysis system 106 determines that there is no potential concurrency problem. If neither thread writes to the memory address, then the order in which the threads are executed is not a potential concurrency problem, so the mere existence of accesses to the same memory address does not create a potential concurrency problem. However, in one or more embodiments the execution analysis system 106 also analyzes whether the values read by the read accesses of the two threads are the same (the values read by each read access is included in the program trace information). If the values read by the read accesses of the two threads are the same then the execution analysis system 106 determines that there is no potential concurrency problem. However, if the values read by the read accesses of the two threads are different, then some other function changed the value of the memory address. The execution analysis system 106 determines that this situation is a potential concurrency problem because the program developer may not have intended the values read by the different read accesses to be different.

If one thread accesses a memory address with a read access and another thread accesses the same memory address with a write access, then the execution analysis system 106 determines that there is a potential concurrency problem because the order in which the accesses occur can change the operations of the functions. In one or more embodiments, the program developer may follow a data model or programming model that specifies (e.g., using particular key words or operations) an ordering in which the reads and writes are to occur. In such situations, the execution analysis system 106 can identify that the proper data model or programming model has been followed to specify the ordering in which the reads and writes occur. In such situations, the execution analysis system 106 can still determine that there is a potential concurrency problem, although can also determine that the severity of the potential concurrency problem is less.

If two threads both access the same memory address with write accesses, then the execution analysis system 106 determines that there is a potential concurrency problem because the order in which the accesses occur can change the operations of the functions.

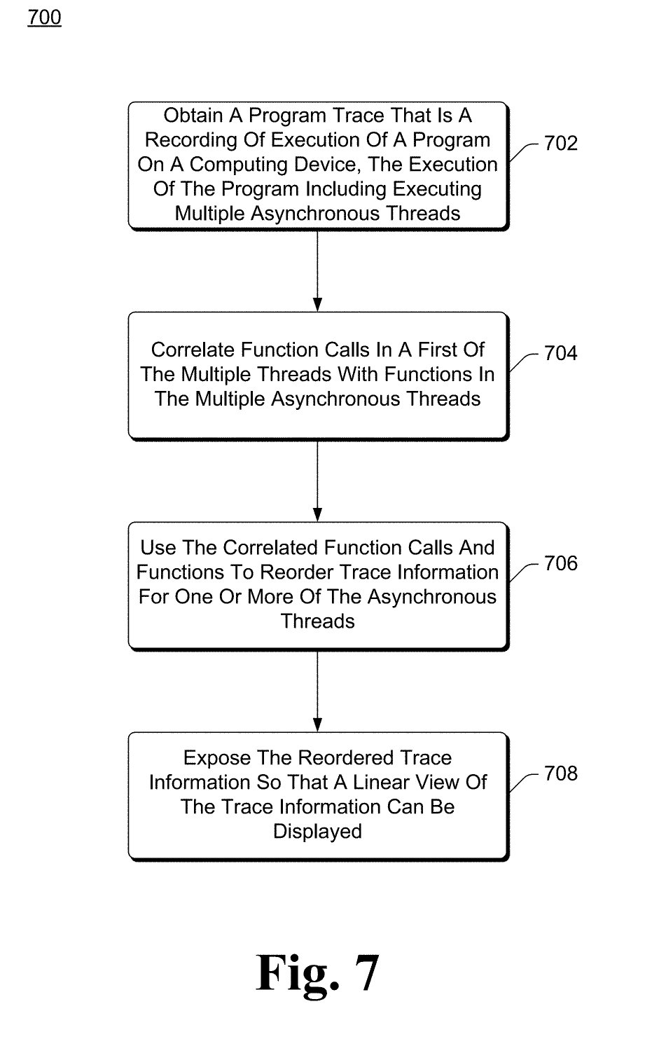

FIG. 7 is a flowchart illustrating an example process 700 for a device implementing the correlation of function calls to functions in asynchronously executed threads in accordance with one or more embodiments. Process 700 is carried out by one or more devices of a system, such as a device implementing at least part of the system 100 of FIG. 1, and can be implemented in software, firmware, hardware, or combinations thereof. Process 700 is shown as a set of acts and is not limited to the order shown for performing the operations of the various acts. Process 700 is an example process for implementing the correlation of function calls to functions in asynchronously executed threads; additional discussions of implementing the correlation of function calls to functions in asynchronously executed threads are included herein with reference to different figures.

In process 700, a program trace that is a recording of execution of multiple threads of a program (act 702). The multiple threads include multiple asynchronous threads that execute functions called from another of the multiple threads. The program trace includes information regarding instructions of the program that is executed on the computing device as discussed above.

Function calls in one of the multiple threads are correlated with functions executed in the multiple asynchronous threads (act 704). This correlation can be performed in various manners as discussed above, such as tags added to the program trace information, characteristics of the function calls and executed functions, and so forth.

The correlated function calls and functions are used to reorder the trace information for one or more of the asynchronous threads (act 706). The trace information is reordered in accordance with the order of code in the program rather than the order in which the asynchronous threads were executed.

The reordered trace information is exposed (act 708). The reordered trace information may include a data structure selected from the group consisting of (a) a data structure indicative of an order in which to use the original trace information, (b) an array of pointers to original trace information, each pointer in the array of pointers corresponding to one or more trace units, the order of the pointers corresponding to an order of the reordered trace information, and (c) a copy of original trace information that has been reordered in memory to be substantially ordered. The reordered trace information may include other conventional means of ordering of data. Exposing the reordered trace information may include storing the reordered trace information in a file, sending the reordered trace information to a receiver of trace information, copying the reordered trace information to a caller-provided memory buffer, copying the reordered trace information to a buffer allocated on behalf of a caller and returning that buffer to the caller, and the like. The exposed reordered trace information may then be displayed so that a linear view of the trace information is displayed. This linear view is a display of the trace information in accordance with the order of the code in the program rather than the order in which the multiple asynchronous threads were executed.

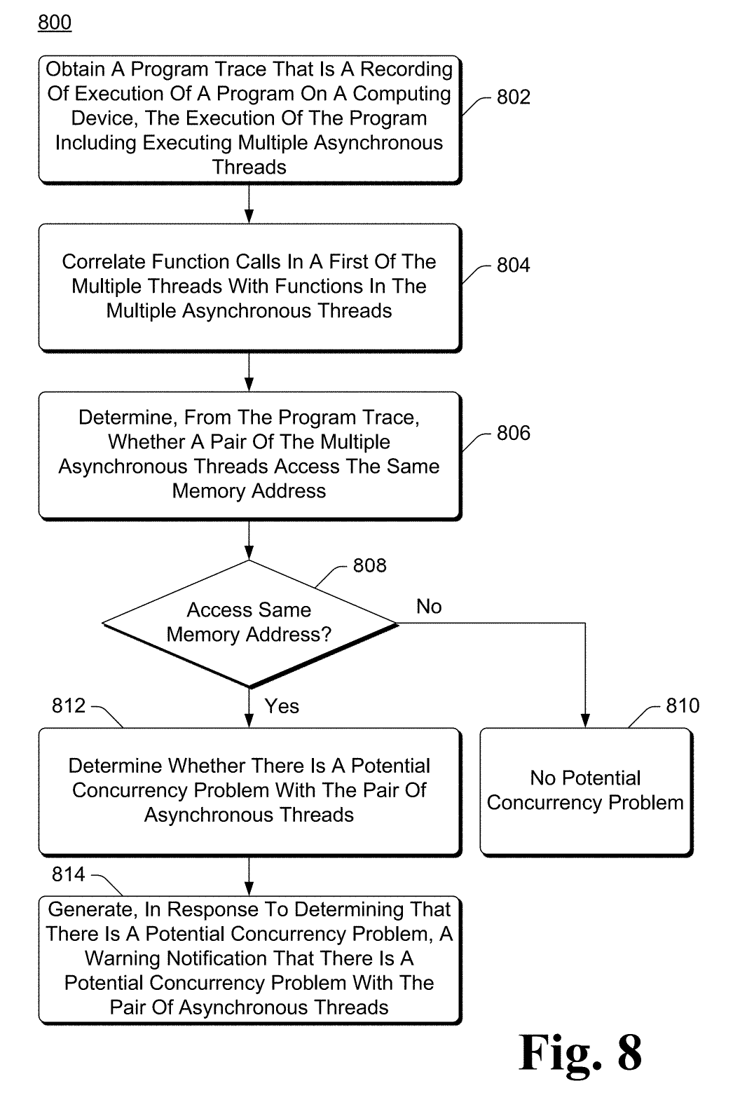

FIG. 8 is a flowchart illustrating an example process 800 for a device implementing the correlation of function calls to functions in asynchronously executed threads in accordance with one or more embodiments. Process 800 is carried out by one or more devices of a system, such as a device implementing at least part of the system 100 of FIG. 1, and can be implemented in software, firmware, hardware, or combinations thereof. Process 800 is shown as a set of acts and is not limited to the order shown for performing the operations of the various acts. Process 800 is an example process for implementing the correlation of function calls to functions in asynchronously executed threads; additional discussions of implementing the correlation of function calls to functions in asynchronously executed threads are included herein with reference to different figures.

In process 800, a program trace that is a recording of execution of multiple threads of a program (act 802). The multiple threads include multiple asynchronous threads that execute functions called from another of the multiple threads. The program trace includes information regarding instructions of the program that is executed on the computing device as discussed above.

Function calls in one of the multiple threads are correlated with functions executed in the multiple asynchronous threads (act 804). This correlation can be performed in various manners as discussed above, such as tags added to the program trace information, characteristics of the function calls and executed functions, and so forth.

A determination is made, from the program trace, whether a pair of the multiple asynchronous threads access a same memory address (act 808). This determination can be made for each of multiple different pairs of asynchronous threads. Process 800 proceeds based on whether, for a given pair of the multiple asynchronous threads, whether the pair of multiple asynchronous threads access a same memory address.

If the pair of asynchronous threads do not access a same memory address, then it is determined that there is no potential concurrency problem (act 810).

However, if the pair of asynchronous threads do access a same memory address, a determination is made as to whether there is a potential concurrency problem with the pair of asynchronous threads (act 812). This determination is made based at least in part on the types of accesses the pair of asynchronous threads make to the same memory address.

In response to determining that there is a potential concurrency problem with the pair of asynchronous threads, a warning notification is generated (act 814). Examples of warning notifications include, without limitation, window messages, calling registered event callbacks, and the like. In some implementations, the generated warning notification results in a warning being displayed. This warning is an indication that there is a potential concurrency problem with the pair of asynchronous threads. The warning optionally includes an indication of the memory address (the memory address that is the same memory address accessed by the pair of asynchronous threads).

Returning to FIG. 1, the execution analysis system 106 can generate various different outputs. In one or more embodiments, the execution analysis system 106 generates a log or report that can be saved to a storage device or communicated to a program developer or user of the system 100. This log or report can be a file or other data structure that includes an output of the program trace information in a linear view in accordance with the order of the code in the program rather than the order in which the asynchronous threads were executed.

Additionally or alternatively, the execution analysis system 106 displays to a user of the system 100 the program trace information in a linear view in accordance with the order of the code in the program (e.g., as illustrated in FIG. 6). Indications of potential concurrency problems can also be displayed to the user of the system 100. These indications can be made in various different manners, such as highlighting, underlining, or otherwise drawing attention to particular trace information. For example, if the execution analysis system 106 determines that there is a potential concurrency problem resulting from Instruction B2 and Instruction C1, then one or both of the Instruction B1 trace information and the Instruction C1 trace information can be highlighted (or underlined, or otherwise have their appearance altered to draw attention to them).

The execution analysis system 106 linearizes the view of the program trace information as discussed above, allowing the trace information to be displayed in accordance with (in the same order as) the order of the code in the program rather than the order in which the asynchronous threads were executed. Furthermore, given the program trace information for the program, the execution analysis system 106 has all of the information it needs to simulate execution of the program in a different order. This information includes the values on the operating system stack, processor register values, inputs to each instruction, outputs from each instruction, and so forth. The execution analysis system 106 can use these values to simulate execution of the instructions in an order other than the order in which instructions were actually executed.

For example assume that Function A, Function B, and Function C are executed in the order shown in FIG. 3. The execution analysis system 106 can display the program trace information in accordance with the order the calls to the functions are made in FIG. 2, which is illustrated in FIG. 6. Given the program trace information, the execution analysis system 106 can also display changes to the operating system stack, processor register values, and so forth for execution of the program in the order illustrated in FIG. 6 rather than the actual order of execution of the instructions. For example, the execution analysis system 106 can display changes to the operating system stack, processor register values, and so forth if instruction B1 were to be executed after instruction Ax (as shown in FIG. 6) rather than instruction C1 being executed after instruction Ax (as shown in FIG. 3).

Returning to FIG. 1, in the discussions herein reference is made to a program trace being generated for a program running on a computing device of the system 100. Information from this program trace is used by the execution analysis system 106 to perform various functionality, such as linearize views of the trace information, identifying potential concurrency problems, and so forth. Additionally or alternatively, rather than generating the program trace, multiple different memory dumps can be taken. A memory dump refers to copying the contents of the memory of a computing device running the program to storage for later use, such as copying the contents of the memory to a file or other record in the program trace store 110 or other storage device. In addition to the contents of the memory, other system values such as processor register values can be stored. These memory dumps can be taken at different times, such as at regular or irregular intervals, in response to certain events (e.g., calling a function, beginning execution of a new thread, etc.).

The information included in these memory dumps can be used analogously to the program trace information. Function calls can be correlated to functions executing in asynchronous threads as discussed above, such as by using various characteristics (e.g., parameter values, return values, etc.) of the function calls and the functions in the threads as recorded by the memory dumps. Given this correlation of function calls to functions executing in asynchronous threads, information from the memory dumps can be reordered so that a linear view of the information from the memory dumps is displayed in accordance with the order of the code in the program rather than the order in which the asynchronous threads were executed. Similarly, potential concurrency problems can be identified using the information in the memory dumps.

It should be noted that memory dumps may not be performed at the same frequency with which information for the program trace is recorded, and thus there may be less information available to the execution analysis system 106 to linearize the display of the memory dump information, identify potential concurrency problems, and so forth. However, to the extent the information is available, the information in the memory dumps can be used analogously to the program trace information.

Although particular functionality is discussed herein with reference to particular modules, it should be noted that the functionality of individual modules discussed herein can be separated into multiple modules, and/or at least some functionality of multiple modules can be combined into a single module. Additionally, a particular module discussed herein as performing an action includes that particular module itself performing the action, or alternatively that particular module invoking or otherwise accessing another component or module that performs the action (or performs the action in conjunction with that particular module). Thus, a particular module performing an action includes that particular module itself performing the action and/or another module invoked or otherwise accessed by that particular module performing the action.

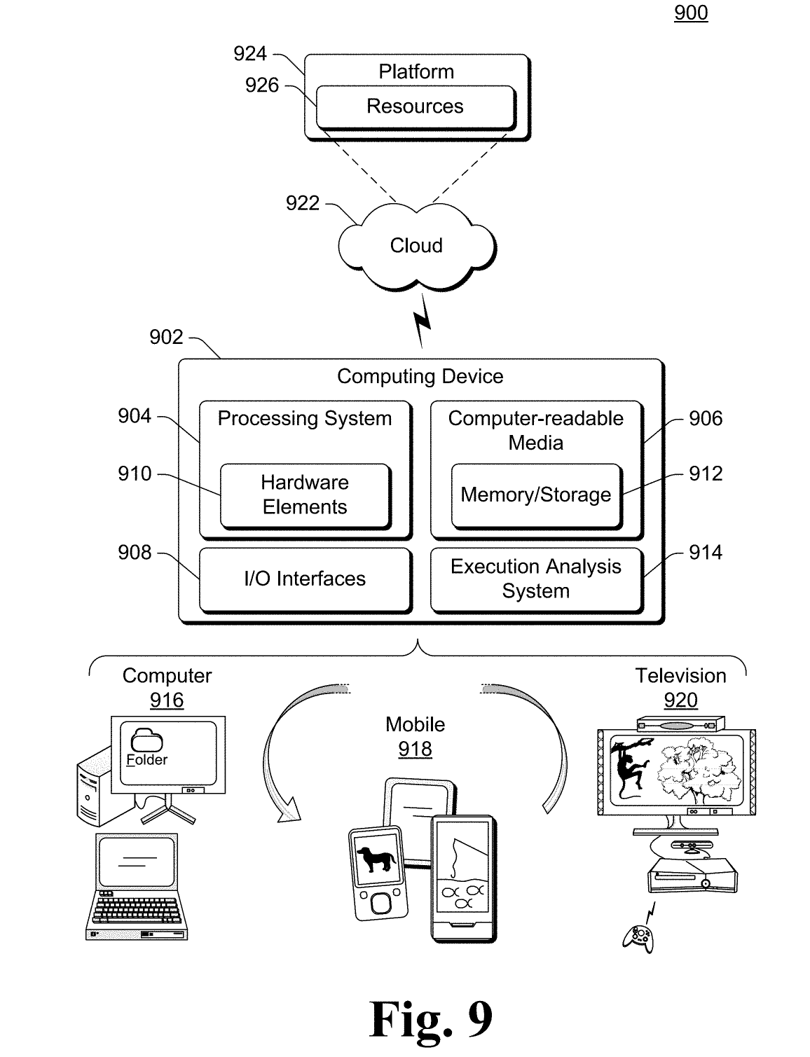

FIG. 9 illustrates an example system generally at 900 that includes an example computing device 902 that is representative of one or more systems and/or devices that may implement the various techniques described herein. The computing device 902 may be, for example, a server of a service provider, a device associated with a client (e.g., a client device), an on-chip system, and/or any other suitable computing device or computing system.

The example computing device 902 as illustrated includes a processing system 904, one or more computer-readable media 906, and one or more I/O Interfaces 908 that are communicatively coupled, one to another. Although not shown, the computing device 902 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware elements 910 that may be configured as processors, functional blocks, and so forth. This may include implementation in hardware as an application specific integrated circuit or other logic device formed using one or more semiconductors. The hardware elements 910 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 906 is illustrated as including memory/storage 912. The memory/storage 912 represents memory/storage capacity associated with one or more computer-readable media. The memory/storage 912 may include volatile media (such as random access memory (RAM)) and/or nonvolatile media (such as read only memory (ROM), Resistive RAM (ReRAM), Flash memory, optical disks, magnetic disks, and so forth). The memory/storage 912 may include fixed media (e.g., RAM, ROM, a fixed hard drive, and so on) as well as removable media (e.g., Flash memory, a removable hard drive, an optical disc, and so forth). The memory/storage 912 may include storage-class memory (SCM) such as 3D Xpoint memory available from Intel Corporation of Santa Clara, Calif. or Micron Technology, Inc. of Boise, Id. The computer-readable media 906 may be configured in a variety of other ways as further described below.

The one or more input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone (e.g., for voice inputs), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 902 may be configured in a variety of ways as further described below to support user interaction.

The computing device 902 also includes an execution analysis system 914. The execution analysis system 914 provides various functionality to correlate function calls to functions in asynchronously executed threads, and use the correlation to display linearized views of program trace information, to identify potential concurrency problems, and so forth as discussed above. The execution analysis system 914 can implement, for example, the execution analysis system 106 of FIG. 1.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of computing platforms having a variety of processors.

An implementation of the described modules and techniques may be stored on or transmitted across some form of computer-readable media. The computer-readable media may include a variety of media that may be accessed by the computing device 902. By way of example, and not limitation, computer-readable media may include “computer-readable storage media” and “computer-readable signal media.”

“Computer-readable storage media” refers to media and/or devices that enable persistent storage of information and/or storage that is tangible, in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refers to a signal-bearing medium that is configured to transmit instructions to the hardware of the computing device 902, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, the hardware elements 910 and computer-readable media 906 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 910. The computing device 902 may be configured to implement particular instructions and/or functions corresponding to the software and/or hardware modules. Accordingly, implementation of modules as a module that is executable by the computing device 902 as software may be achieved at least partially in hardware, e.g., through use of computer-readable storage media and/or hardware elements 910 of the processing system. The instructions and/or functions may be executable/operable by one or more articles of manufacture (for example, one or more computing devices 902 and/or processing systems 904) to implement techniques, modules, and examples described herein.

As further illustrated in FIG. 9, the example system 900 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 900, multiple devices are interconnected through a central computing device. The central computing device may be local to the multiple devices or may be located remotely from the multiple devices. In one or more embodiments, the central computing device may be a cloud of one or more server computers that are connected to the multiple devices through a network, the Internet, or other data communication link.

In one or more embodiments, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one or more embodiments, a class of target devices is created and experiences are tailored to the generic class of devices. A class of devices may be defined by physical features, types of usage, or other common characteristics of the devices.

In various implementations, the computing device 902 may assume a variety of different configurations, such as for computer 916, mobile 918, and television 920 uses. Each of these configurations includes devices that may have generally different constructs and capabilities, and thus the computing device 902 may be configured according to one or more of the different device classes. For instance, the computing device 902 may be implemented as the computer 916 class of a device that includes a personal computer, desktop computer, a multi-screen computer, laptop computer, netbook, and so on.

The computing device 902 may also be implemented as the mobile 918 class of device that includes mobile devices, such as a mobile phone, portable music player, portable gaming device, a tablet computer, a multi-screen computer, and so on. The computing device 902 may also be implemented as the television 920 class of device that includes devices having or connected to generally larger screens in casual viewing environments. These devices include televisions, set-top boxes, gaming consoles, and so on.

The techniques described herein may be supported by these various configurations of the computing device 902 and are not limited to the specific examples of the techniques described herein. This functionality may also be implemented all or in part through use of a distributed system, such as over a “cloud” 922 via a platform 924 as described below.

The cloud 922 includes and/or is representative of a platform 924 for resources 926. The platform 924 abstracts underlying functionality of hardware (e.g., servers) and software resources of the cloud 922. The resources 926 may include applications and/or data that can be utilized while computer processing is executed on servers that are remote from the computing device 902. Resources 926 can also include services provided over the Internet and/or through a subscriber network, such as a cellular or Wi-Fi network.

The platform 924 may abstract resources and functions to connect the computing device 902 with other computing devices. The platform 924 may also serve to abstract scaling of resources to provide a corresponding level of scale to encountered demand for the resources 926 that are implemented via the platform 924. Accordingly, in an interconnected device embodiment, implementation of functionality described herein may be distributed throughout the system 900. For example, the functionality may be implemented in part on the computing device 902 as well as via the platform 924 that abstracts the functionality of the cloud 922.

In the discussions herein, various different embodiments are described. It is to be appreciated and understood that each embodiment described herein can be used on its own or in connection with one or more other embodiments described herein. Further aspects of the techniques discussed herein relate to one or more of the following embodiments.

A method comprising: obtaining a program trace that is a recording of execution of multiple threads of a program on a computing device, the multiple threads including multiple asynchronous threads, the program trace including information regarding instructions of the program that is executed on the computing device; correlating function calls in a first of the multiple threads with functions executed in the multiple asynchronous threads; using the correlated function calls and functions to reorder the trace information for one or more of the asynchronous threads in accordance with the order of code in the program rather than the order in which the asynchronous threads were executed; and exposing the reordered trace information so that a linear view of the trace information in accordance with the order of the code in the program rather than the order in which the multiple asynchronous threads were executed is available.

Alternatively or in addition to any of the methods or devices described herein, any one or combination of: the information regarding instructions of the program comprising values or locations of inputs to the instructions, and values or locations of outputs by the instructions; the correlating comprising identifying, in the program trace, a tag value associated with a function call in the first thread, identifying, from the program trace, a second thread that executes a function, the second thread being one of the one or more additional asynchronous threads and having the tag value, and correlating the function call in the first thread and the function executed in the second thread; the correlating comprising identifying, in the program trace, characteristics of a function call in the first thread, identifying, from the program trace, a second thread that executes a function, the second thread being one of the one or more additional asynchronous threads and having the same characteristics as the function call in the first thread, and correlating the function call in the first thread and the function executed in the second thread; the characteristics of the function call in the first thread comprising parameter values of the function call in the first thread; the characteristics of the function call in the first thread further comprising a return value received in response to the function call in the first thread; the method further comprising determining, from the program trace, whether a pair of the multiple asynchronous threads accessed a same memory address, and in response to determining that the pair of asynchronous threads accessed the same memory address determining, based at least in part on the types of accesses the pair of asynchronous threads made to the same memory address, whether there is a potential concurrency problem with the pair of asynchronous threads, the types of accesses including read accesses or write accesses, and generating, in response to determining that there is a potential concurrency problem with the pair of asynchronous threads, a warning notification that there is a potential concurrency problem with the pair of asynchronous threads, the warning including an indication of the memory address.

A method comprising: obtaining a program trace that is a recording of execution of multiple threads of a program on a computing device, the multiple threads including multiple asynchronous threads, the program trace including information regarding instructions of the program that is executed on the computing device; correlating function calls in a first of the multiple threads with functions executed in the multiple asynchronous threads; determining, from the program trace, whether a pair of the multiple asynchronous threads accessed a same memory address; and in response to determining that the pair of asynchronous threads accessed the same memory address: determining, based at least in part on the types of accesses the pair of asynchronous threads made to the same memory address, whether there is a potential concurrency problem with the pair of asynchronous threads, the types of accesses including read accesses or write accesses; and generating, in response to determining that there is a potential concurrency problem with the pair of asynchronous threads, a warning notification that there is a potential concurrency problem with the pair of asynchronous threads, the warning including an indication of the memory address.

Alternatively or in addition to any of the methods or devices described herein, any one or combination of: the information regarding instructions of the program comprising values or locations of inputs to the instructions, and values or locations of outputs by the instructions; the correlating comprising identifying, in the program trace, a tag value associated with a function call in the first thread, identifying, from the program trace, a second thread that executes a function, the second thread being one of the one or more additional asynchronous threads and having the tag value, and correlating the function call in the first thread and the function executed in the second thread; the correlating comprising identifying, in the program trace, characteristics of a function call in the first thread, identifying, from the program trace, a second thread that executes a function, the second thread being one of the one or more additional asynchronous threads and having the same characteristics as the function call in the first thread, and correlating the function call in the first thread and the function executed in the second thread; the characteristics of the function call in the first thread comprising parameter values of the function call in the first thread; the characteristics of the function call in the first thread further comprising a return value received in response to the function call in the first thread; the determining whether there is a potential concurrency problem comprising determining that there is no potential concurrency problem if each of the pair of asynchronous threads accesses the same memory address with only read accesses; the determining further comprising determining, for the read accesses to the same memory address by the pair of asynchronous threads, whether each read access read a same value, determining, in response to each read access to the same memory address by the pair of asynchronous threads having read the same value, that there is no potential concurrency problem, and determining, in response to two or more read accesses to the same memory address by the pair of asynchronous threads having read different values, that there is a potential concurrency problem; the determining whether there is a potential concurrency problem comprising determining that there is a potential concurrency problem if a first thread of the pair of asynchronous threads accessed the same memory address with a read access and a second thread of the pair of asynchronous threads accessed the same memory address with a write access; the determining whether there is a potential concurrency problem comprising determining that there is a potential concurrency problem if each of the pair of asynchronous threads accessed the same memory address with write accesses.

A computing device comprising: a processor; and a computer-readable storage medium having stored thereon multiple instructions that, responsive to execution by the processor, cause the processor to: obtain a program trace that is a recording of execution of multiple threads of a program on the computing device, the multiple threads including multiple asynchronous threads, the program trace including information regarding instructions of the program that is executed on the computing device; correlate function calls in a first of the multiple threads with functions executed in the multiple asynchronous threads; use the correlated function calls and functions to reorder the trace information for one or more of the asynchronous threads in accordance with the order of code in the program rather than the order in which the asynchronous threads were executed; and expose the reordered trace information so that a linear view of the trace information in accordance with the order of the code in the program rather than the order in which the multiple asynchronous threads were executed is available.

Alternatively or in addition to any of the methods or devices described herein, any one or combination of: the multiple instructions further causing the processor to: determine, from the program trace, whether a pair of the multiple asynchronous threads accessed a same memory address, and in response to determining that the pair of asynchronous threads accessed the same memory address determine, based at least in part on the types of accesses the pair of asynchronous threads made to the same memory address, whether there is a potential concurrency problem with the pair of asynchronous threads, the types of accesses including read accesses or write accesses, and generate, in response to determining that there is a potential concurrency problem with the pair of asynchronous threads, a warning notification that there is a potential concurrency problem with the pair of asynchronous threads, the warning including an indication of the memory address; wherein to correlate function calls in the first of the multiple threads with functions executed in the multiple asynchronous threads is to identify, in the program trace, characteristics of a function call in the first thread, identify, from the program trace, a second thread that executes a function, the second thread being one of the one or more additional asynchronous threads and having the same characteristics as the function call in the first thread, and correlate the function call in the first thread and the function executed in the second thread.

A computing device comprising: a processor; and a computer-readable storage medium having stored thereon multiple instructions that, responsive to execution by the processor, cause the processor to: obtain a program trace that is a recording of execution of multiple threads of a program on a computing device, the multiple threads including multiple asynchronous threads, the program trace including information regarding instructions of the program that is executed on the computing device; correlate function calls in a first of the multiple threads with functions executed in the multiple asynchronous threads; determine, from the program trace, whether a pair of the multiple asynchronous threads accessed a same memory address; and in response to determining that the pair of asynchronous threads accessed the same memory address: determine, based at least in part on the types of accesses the pair of asynchronous threads made to the same memory address, whether there is a potential concurrency problem with the pair of asynchronous threads, the types of accesses including read accesses or write accesses; and generate, in response to determining that there is a potential concurrency problem with the pair of asynchronous threads, a warning notification that there is a potential concurrency problem with the pair of asynchronous threads, the warning including an indication of the memory address.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
obtaining a program trace that is a recording of execution of multiple threads of a program on a computing device, the multiple threads including multiple asynchronous threads, the program trace including information regarding instructions of the program that is executed on the computing device;
correlating function calls in a first of the multiple threads with functions executed in the multiple asynchronous threads;
using the correlated function calls and functions to reorder the trace information for one or more of the asynchronous threads in accordance with the order of code in the program rather than the order in which the asynchronous threads were executed; and
exposing the reordered trace information so that a linear view of the trace information in accordance with the order of the code in the program rather than the order in which the multiple asynchronous threads were executed is available.

2. The method as recited in claim 1, the information regarding instructions of the program comprising values or locations of inputs to the instructions, and values or locations of outputs by the instructions.

3. The method as recited in claim 1, the correlating comprising:
identifying, in the program trace, a tag value associated with a function call in the first thread;
identifying, from the program trace, a second thread that executes a function, the second thread being one of the one or more additional asynchronous threads and having the tag value; and
correlating the function call in the first thread and the function executed in the second thread.

4. The method as recited in claim 1, the correlating comprising:
identifying, in the program trace, characteristics of a function call in the first thread;
identifying, from the program trace, a second thread that executes a function, the second thread being one of the one or more additional asynchronous threads and having the same characteristics as the function call in the first thread; and
correlating the function call in the first thread and the function executed in the second thread.

5. The method as recited in claim 4, the characteristics of the function call in the first thread comprising parameter values of the function call in the first thread.

6. The method as recited in claim 5, the characteristics of the function call in the first thread further comprising a return value received in response to the function call in the first thread.

7. The method as recited in claim 1, further comprising:
determining, from the program trace, whether a pair of the multiple asynchronous threads accessed a same memory address; and
in response to determining that the pair of asynchronous threads accessed the same memory address:
determining, based at least in part on the types of accesses the pair of asynchronous threads made to the same memory address, whether there is a potential concurrency problem with the pair of asynchronous threads, the types of accesses including read accesses or write accesses; and
generating, in response to determining that there is a potential concurrency problem with the pair of asynchronous threads, a warning notification that there is a potential concurrency problem with the pair of asynchronous threads, the warning including an indication of the memory address.

8. A method comprising:
obtaining a program trace that is a recording of execution of multiple threads of a program on a computing device, the multiple threads including multiple asynchronous threads, the program trace including information regarding instructions of the program that is executed on the computing device;
correlating function calls in a first of the multiple threads with functions executed in the multiple asynchronous threads;
determining, from the program trace, whether a pair of the multiple asynchronous threads accessed a same memory address; and
in response to determining that the pair of asynchronous threads accessed the same memory address:
determining, based at least in part on the types of accesses the pair of asynchronous threads made to the same memory address, whether there is a potential concurrency problem with the pair of asynchronous threads, the types of accesses including read accesses or write accesses; and
generating, in response to determining that there is a potential concurrency problem with the pair of asynchronous threads, a warning notification that there is a potential concurrency problem with the pair of asynchronous threads, the warning including an indication of the memory address.

9. The method as recited in claim 8, the information regarding instructions of the program comprising values or locations of inputs to the instructions, and values or locations of outputs by the instructions.

10. The method as recited in claim 8, the correlating comprising:
identifying, in the program trace, a tag value associated with a function call in the first thread;
identifying, from the program trace, a second thread that executes a function, the second thread being one of the one or more additional asynchronous threads and having the tag value; and
correlating the function call in the first thread and the function executed in the second thread.

11. The method as recited in claim 8, the correlating comprising:
identifying, in the program trace, characteristics of a function call in the first thread;
identifying, from the program trace, a second thread that executes a function, the second thread being one of the one or more additional asynchronous threads and having the same characteristics as the function call in the first thread; and
correlating the function call in the first thread and the function executed in the second thread.

12. The method as recited in claim 11, the characteristics of the function call in the first thread comprising parameter values of the function call in the first thread.

13. The method as recited in claim 12, the characteristics of the function call in the first thread further comprising a return value received in response to the function call in the first thread.

14. The method as recited in claim 8, the determining whether there is a potential concurrency problem comprising determining that there is no potential concurrency problem if each of the pair of asynchronous threads accesses the same memory address with only read accesses.

15. The method as recited in claim 14, the determining further comprising:
determining, for the read accesses to the same memory address by the pair of asynchronous threads, whether each read access read a same value;
determining, in response to each read access to the same memory address by the pair of asynchronous threads having read the same value, that there is no potential concurrency problem; and
determining, in response to two or more read accesses to the same memory address by the pair of asynchronous threads having read different values, that there is a potential concurrency problem.

16. The method as recited in claim 8, the determining whether there is a potential concurrency problem comprising determining that there is a potential concurrency problem if a first thread of the pair of asynchronous threads accessed the same memory address with a read access and a second thread of the pair of asynchronous threads accessed the same memory address with a write access.

17. The method as recited in claim 8, the determining whether there is a potential concurrency problem comprising determining that there is a potential concurrency problem if each of the pair of asynchronous threads accessed the same memory address with write accesses.

18. A computing device comprising:
a processor; and
a computer-readable storage medium having stored thereon multiple instructions that, responsive to execution by the processor, cause the processor to:
obtain a program trace that is a recording of execution of multiple threads of a program on the computing device, the multiple threads including multiple asynchronous threads, the program trace including information regarding instructions of the program that is executed on the computing device;
correlate function calls in a first of the multiple threads with functions executed in the multiple asynchronous threads;
use the correlated function calls and functions to reorder the trace information for one or more of the asynchronous threads in accordance with the order of code in the program rather than the order in which the asynchronous threads were executed; and
expose the reordered trace information so that a linear view of the trace information in accordance with the order of the code in the program rather than the order in which the multiple asynchronous threads were executed is available.

19. The computing device as recited in claim 18, the multiple instructions further causing the processor to:
determine, from the program trace, whether a pair of the multiple asynchronous threads accessed a same memory address; and
in response to determining that the pair of asynchronous threads accessed the same memory address:
determine, based at least in part on the types of accesses the pair of asynchronous threads made to the same memory address, whether there is a potential concurrency problem with the pair of asynchronous threads, the types of accesses including read accesses or write accesses; and
generate, in response to determining that there is a potential concurrency problem with the pair of asynchronous threads, a warning notification that there is a potential concurrency problem with the pair of asynchronous threads, the warning including an indication of the memory address.

20. The computing device as recited in claim 18, wherein to correlate function calls in the first of the multiple threads with functions executed in the multiple asynchronous threads is to:
identify, in the program trace, characteristics of a function call in the first thread;
identify, from the program trace, a second thread that executes a function, the second thread being one of the one or more additional asynchronous threads and having the same characteristics as the function call in the first thread; and
correlate the function call in the first thread and the function executed in the second thread.
